(19) United States
(12) Patent Application Publication
(10) Pub. No.: US 2020/0118356 A1
(43) Pub. Date: Apr. 16, 2020

(54) INFORMATION PROCESSING APPARATUS AND COMPUTER-READABLE RECORDING MEDIUM INCLUDING PROGRAM

(71) Applicant: SUBARU CORPORATION, Tokyo (JP)

(72) Inventors: Hirofumi IIKUMA, Tokyo (JP); Atsushi TAKAHASHI, Tokyo (JP)

(21) Appl. No.: 16/589,849

(22) Filed: Oct. 1, 2019

(30) Foreign Application Priority Data
Oct. 12, 2018 (JP) 2018-193211

(51) Int. Cl. G07C 5/00; G07C 5/08; G01M 17/00

(52) U.S. Cl. CPC G07C 5/008; G01M 17/00; G07C 5/0816

(57) ABSTRACT

An information processing apparatus includes a controller, a screen data transmitter, and a receiver. The controller generates, on a basis of progress information indicating a progress status of inspection of a vehicle, first Web screen data directed to displaying a first Web screen that presents a procedure of inspecting the vehicle. The screen data transmitter transmits the first Web screen data to a first communication terminal. The receiver receives the progress information and inspection information of the vehicle, which are transmitted from the first communication terminal in response to a user operation, the user operation being performed on the first communication terminal displaying the first Web screen. The controller generates second Web screen data directed to displaying a second Web screen that presents the inspection information. The screen data transmitter transmits the second Web screen data to a second communication terminal.

### CROSS-REFERENCE TO RELATED APPLICATIONS

The present application claims priority from Japanese Patent Application No. 2018-193211 filed on Oct. 12, 2018, the entire contents of which are hereby incorporated by reference.

### BACKGROUND

The technology relates to an information processing apparatus and a computer-readable recording medium including a program.

There has been technologies of assisting inspection of vehicles. For example, Japanese Unexamined Patent Application Publication (JP-A) No. 2014-215052 describes the following technology. A cumulative traveling distance of a vehicle that is traveling is detected, and in a case where the cumulative traveling distance becomes a preset cumulative traveling distance, a message indicating that preset items have to be inspected is transmitted to the traveling vehicle.

### SUMMARY

An aspect of the technology provides an information processing apparatus including a controller, a screen data transmitter, and a receiver. The controller is configured to generate, on a basis of progress information indicating a progress status of inspection of a vehicle, first Web screen data directed to displaying a first Web screen that presents a procedure of inspecting the vehicle. The screen data transmitter is configured to transmit the first Web screen data to a first communication terminal. The receiver is configured to receive the progress information and inspection information of the vehicle, the progress information and the inspection information being transmitted from the first communication terminal in response to a user operation, the user operation being performed on the first communication terminal that has received the first Web screen data and displayed the first Web screen. The controller is configured to generate second Web screen data directed to displaying a second Web screen that presents the inspection information. The screen data transmitter is configured to transmit the second Web screen data to a second communication terminal.

An aspect of the technology provides a non-transitory computer-readable recording medium including a program. that causes, when executed by a computer, the computer to implement a method. The method includes: generating, on a basis of progress information indicating a progress status of inspection of a vehicle, first Web screen data directed to displaying a first Web screen that presents a procedure of inspecting the vehicle; transmitting the first Web screen data to a first communication terminal; receiving the progress information and inspection information of the vehicle, the progress information and the inspection information being transmitted from the first communication terminal in response to an input operation, the input operation being performed on the first communication terminal that has received the first Web screen data and displayed the first Web screen; generating second Web screen data directed to displaying a second Web screen that presents the inspection information; and transmitting the second Web screen data to a second communication terminal.

An aspect of the technology provides a vehicle control apparatus including a controller and circuitry. The controller is configured to generate, on a basis of progress information indicating a progress status of inspection of a vehicle, first Web screen data directed to displaying a first Web screen that presents a procedure of inspecting the vehicle. The circuitry is configured to transmit the first Web screen data to a first communication terminal, and receive the progress information and inspection information of the vehicle, the progress information and the inspection information being transmitted from the first communication terminal in response to a user operation, the user operation being performed on the first communication terminal that has received the first Web screen data and displayed the first Web screen. The controller is configured to generate second Web screen data directed to displaying a second Web screen that presents the inspection information. The circuitry is configured to transmit the second Web screen data to a second communication terminal.

### BRIEF DESCRIPTION OF THE DRAWINGS

The accompanying drawings are included to provide a further understanding of the technology and are incorporated in and constitute a part of this specification. The drawings illustrate example embodiments and, together with the specification, serve to explain the principles of the technology.

FIG. 1 is a block diagram illustrating a configuration of an information processing system according to one example embodiment of the technology.

FIG. 2 is a block diagram illustrating a configuration of an information processing apparatus according to one example embodiment of the technology.

FIG. 3 is a block diagram illustrating a configuration of a first communication terminal.

FIG. 4 is a diagram illustrating an example of a first Web screen that presents a flow of inspection work.

FIG. 5 is a diagram illustrating an example of a first Web screen that presents an example procedure of inspection work.

FIG. 6 is a diagram illustrating an example of a second Web screen according to one example embodiment of the technology.

FIG. 7 is a flowchart illustrating processes performed by an information processing apparatus. The processes start with a process in which the information processing apparatus is requested from a first communication terminal to execute a program directed to transmitting Web screen data, and end with a process in which the information processing apparatus receives vehicle information from the first communication terminal.

FIG. 8 is a flowchart illustrating processes in which an information processing apparatus transmits first Web screen data to a first communication terminal in response to data transmitted from the first communication terminal.

### DETAILED DESCRIPTION

### 0. Overview

In a case where abnormality occurs in a vehicle, an inspector inspects the vehicle in which abnormality has occurred, in accordance with a vehicle diagnosis procedure manual. In a case where the inspector is unable to find a cause of abnormality in the vehicle even by referring to the diagnosis procedure manual, the inspector inquires of an adviser such as a dealer of a manufacturer of the vehicle, and performs inspection work on the basis of an answer from the adviser.

However, in a case where the adviser who has received the inquiry from the inspector hears detailed information, such as a progress status of inspection of the vehicle, from the inspector, it takes time for the adviser to acquire information necessary for giving advice. Moreover, in a case where the adviser fails to acquire accurate information from the inspector, the adviser is unable to give accurate advice to the inspector.

The technology described in JP-A No. 2014-215052 issues a notification of inspection contents while the vehicle is traveling, and accordingly is not a technology intended to give advice about inspection to the inspector.

It is desirable to provide an information processing apparatus and a computer-readable recording medium including a program that make it possible to present an inspection procedure to an inspector of a vehicle, and easily provide, to a third party, a result of inspection performed on the basis of the inspection procedure.

In the following, some example embodiments of the technology are described with reference to the accompanying drawings. Note that the following description is directed to illustrative examples of the technology and not to be construed as limiting to the technology. In each of the drawings referred to in the following description, elements have different scales in order to illustrate the respective elements with sizes recognizable in the drawings. Therefore, factors including, without limitation, the number of each of the elements, the shape of each of the elements, a size of each of the elements, a ratio between the elements, and relative positional relationship between the elements are illustrative only and not to be construed as limiting to the technology. Further, elements in the following example embodiments which are not recited in a most-generic independent claim of the technology are optional and may be provided on an as-needed basis. Throughout the present specification and the drawings, elements having substantially the same function and configuration are denoted with the same numerals to avoid any redundant description.

### 1. Information Processing System

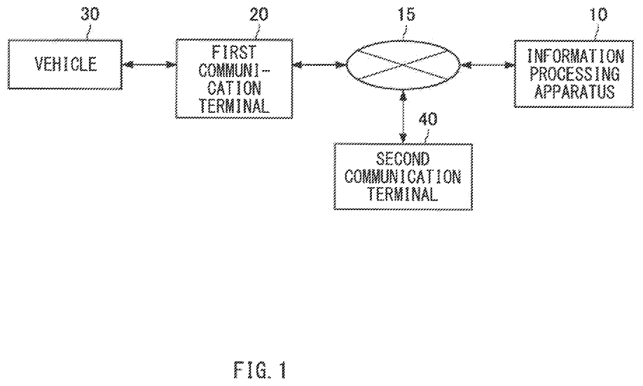

An information processing system according to an example embodiment of the technology will be described with reference to FIG. 1. FIG. 1 is a block diagram illustrating a configuration of an information processing system according to the example embodiment of the technology. The information processing system may include an information processing apparatus 10, a first communication terminal 20, a vehicle 30, and a second communication terminal 40. The information processing apparatus 10, the first communication terminal 20, and the second communication terminal 40 may be coupled to one another via a network 15.

Here, a first user, who is a user of the first communication terminal 20, may be an inspector who inspects the vehicle 30. The inspector may inspect the vehicle 30 while viewing a Web screen that is displayed on a display unit included in the first communication terminal 20. A second user, who is a user of the second communication terminal 40, may be an adviser who gives advice about inspection of the vehicle 30 to the inspector of the vehicle 30.

### [Information Processing Apparatus]

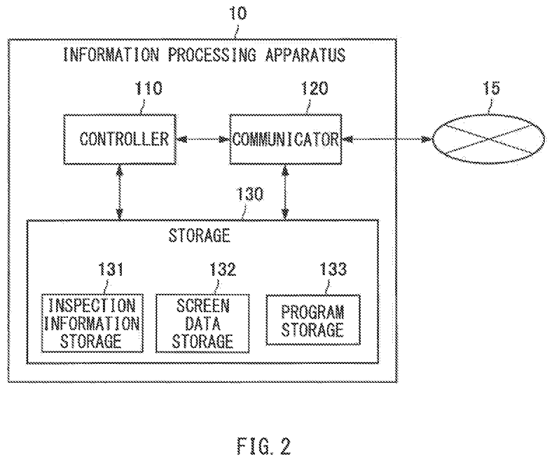

The configuration of the information processing apparatus 10 will be described with reference to FIG. 2. On the basis of progress information indicating a progress status of inspection of the vehicle 30, the information processing apparatus 10 generates first Web screen data directed to displaying a first Web screen that presents a procedure of inspecting the vehicle 30, and transmits the first Web screen data to the first communication terminal 20. The information processing apparatus 10 may also receive the progress information, inspection information, and vehicle information. The progress information and the inspection information may be transmitted from the first communication terminal 20 by a user operating the first communication terminal 20, the user viewing the first Web screen displayed on the first communication terminal 20. The vehicle information may be transmitted from the first communication terminal 20. The information processing apparatus 10 receives the progress information and inspection information of the vehicle 30. The progress information and the inspection information are transmitted from the first communication terminal 20 in response to a user operation. The user operation is performed on the first communication terminal 20 that has received the first Web screen data and displayed the first Web screen. Furthermore, the information processing apparatus 10 may generate second Web screen data directed to displaying a second Web screen that presents the inspection information and vehicle information, and transmit the second Web screen data to the second communication terminal 40. These operations of the information processing apparatus 10 may be achieved by a controller 110, a communicator 120, and a storage 130 that are included in the information processing apparatus 10. The controller 110 may execute a program stored in the storage 130, which enables the information processing apparatus 10 to execute the above-described various operations. In one embodiment of the technology, the controller 110 may serve as a “controller”. In one embodiment of the technology, the communicator 120 may serve as a “screen data transmitter” and a “receiver”. In one embodiment of the technology, the storage 130 may serve as a “computer-readable recording medium”.

The controller 110 may generate Web screen data directed to displaying a Web screen. In some embodiments, a Web screen refers to a screen that is able to be put on public view on the Internet by using a World Wide Web (WWW) system. In some embodiments, Web screen data may include information such as text data, layout information written in Hyper Text Markup Language (HTML), and an image, a sound, or a moving image embedded in a document. The controller 110 may transfer the generated Web screen data to the communicator 120 or the storage 130. The controller 110 may, for example, cause the storage 130 to store the generated Web screen data. The Web screen data transferred to the communicator 120 may be transmitted, via the network 15, to, for example, the first communication terminal 20 or the second communication terminal 40 that is coupled to the network 15. The storage 130 may be able to store Web screen data.

The controller 110 generates first Web screen data directed to displaying a first Web screen that presents a procedure of inspecting the vehicle 30 on the basis of progress information of the vehicle 30. In one example, the controller 110 may generate Web screen data on the basis of progress information of the vehicle 30, by using source data of the Web screen data. The source data may be stored in the storage 130. Note that the progress information may be transmitted from the first communication terminal 20 to the information processing apparatus 10 via the network 15.

The controller 110 may also associate the inspected vehicle 30 with a vehicle identification number (VIN). As will be described later, inspection information may be transmitted from the first communication terminal 20 to the information processing apparatus 10 via the network 15. The inspection information may indicate contents of inspection of the vehicle 30 performed by the inspector and results of the inspection, for example. The controller 110 may associate the inspection information with the vehicle identification number, and cause the storage 130 to store the inspection information.

The controller 110 also generates second Web screen data directed to displaying a second Web screen that presents inspection information. The controller 110 may transfer the generated second Web screen data to the communicator 120 or the storage 130. The communicator 120 may transmit, via the network 15, the second Web screen data to any communication terminal that is coupled to the network 15. The second Web screen data may be transmitted to, for example, the second communication terminal 40. Thus, the second Web screen may be displayed on a display unit included in the second communication terminal 40. By viewing the second Web screen, the second user is able to check inspection information of the vehicle 30. The controller 110 may, for example, cause the storage 130 to store the generated second Web screen data. Thus, the second Web screen data transferred to the storage 130 may be stored in the storage 130.

Furthermore, the controller 110 may generate second Web screen data that indicates inspection information by associating the vehicle 30 with a vehicle identification number. The controller 110 may transfer the generated second Web screen data to the communicator 120 or the storage 130. When the second Web screen data is transmitted to the second communication terminal 40, for example, inspection information of the vehicle 30 associated with the vehicle identification number may be displayed on the display unit included in the second communication terminal 40. This enables the second user to recognize inspection information of the vehicle 30 in association with the vehicle identification number. The controller 110 may, for example, cause the storage 130 to store the second Web screen data. Thus, the second Web screen data transferred to the storage 130 may be stored in the storage 130.

The communicator 120 may communicate with an external communication terminal. In one example, the communicator 120 may transmit first Web screen data to the first communication terminal 20. Thus, a first Web screen may be displayed on the display unit included in the first communication terminal 20. The first user is able to inspect the vehicle 30 while viewing an inspection procedure displayed on the first Web screen.

The communicator 120 may also transmit, to the second communication terminal 40, second Web screen data that indicates inspection information such as inspection contents or inspection results of the vehicle 30. A second Web screen may be displayed on the display unit included in the second communication terminal 40 that has received the second Web screen data. While viewing the second Web screen, the adviser, i.e., the second user, is able to give advice about inspection of the vehicle 30 to the inspector, i.e., the first user.

The storage 130 may store information. For example, the storage 130 may store information such as progress information and inspection information of the vehicle 30, Web screen data, source data of Web screen data, and a program directed to generating Web screen data. Operations of the storage 130 may be achieved by an inspection information storage 131, a screen data storage 132, and a program storage 133 that are included in the storage 130. The storage 130 may transfer the stored information to the controller 110 or the communicator 120. The storage 130 may include, for example, a semiconductor memory or a hard disk.

The inspection information storage 131 may store progress information and inspection information, such as inspection contents and inspection results, of the vehicle 30. The inspection information storage 131 may transfer the stored inspection information to the controller 110. The controller 110 may generate Web screen data on the basis of the inspection information.

The screen data storage 132 may store Web screen data generated by the controller 110 and source data of Web screen data. The screen data storage 132 may transfer source data of Web screen data to the controller 110. The controller 110 may generate Web screen data on the basis of the source data. The screen data storage 132 may also transfer Web screen data to the communicator 120. The communicator 120 may transmit the Web screen data to an external communication terminal such as the first communication terminal 20.

The program storage 133 may store a program directed to causing the information processing apparatus 10 to execute the above-described various operations, such as generating Web screen data. In one example, the program stored in the program storage 133 may cause the information processing apparatus 10 to execute the following operations. The controller 110 may execute the above-described various operations, such as generating Web screen data, on the basis of the program.
On the basis of progress information indicating a progress status of inspection of the vehicle 30, generating first Web screen data directed to displaying a first Web screen that presents a procedure of inspecting the vehicle 30, and transmitting the first Web screen data to the first communication terminal 20.
Receiving the progress information, inspection information, and vehicle information. The progress information and the inspection information may be transmitted from the first communication terminal 20 by a user operating the first communication terminal 20, the user viewing the first Web screen displayed on the first communication terminal 20. The vehicle information may be transmitted from the first communication terminal 20.
Receiving the progress information and inspection information of the vehicle 30. The progress information and the inspection information are transmitted from the first communication terminal 20 in response to a user operation. The user operation is performed on the first communication terminal 20 that has received the first Web screen data and displayed the first Web screen.
Generating second Web screen data directed to displaying a second Web screen that presents the inspection information and vehicle information, and transmitting the second Web screen data to the second communication terminal 40.

### [First Communication Terminal]

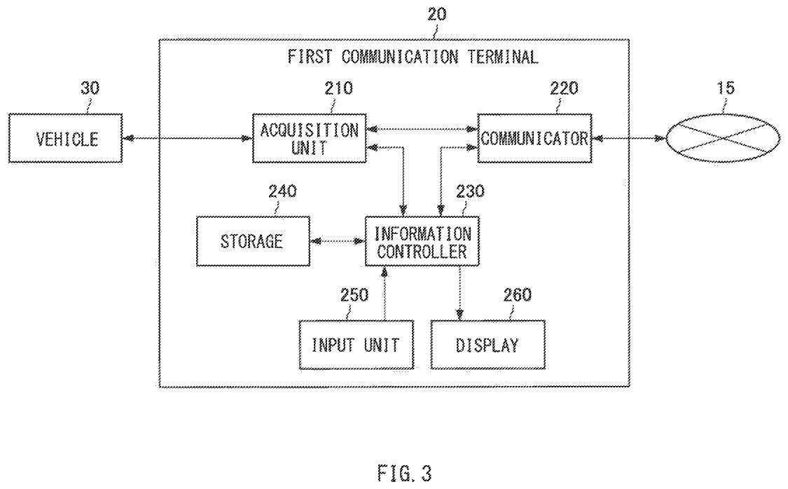

Now, a configuration of the first communication terminal 20 will be described with reference to FIG. 3. The first communication terminal 20 may display a Web screen, on the basis of Web screen data received from the information processing apparatus 10. The first communication terminal 20 may also transmit inspection information of the vehicle 30 to the information processing apparatus 10 via the network 15, in response to input from the first user to the first communication terminal 20. Furthermore, the first communication terminal 20 may acquire vehicle information from the vehicle 30, and transmit the vehicle information via the network 15. Operations of the first communication terminal 20 may be achieved by an acquisition unit 210, a communicator 220, an information controller 230, a storage 240, an input unit 250, and a display 260 that are included in the first communication terminal 20.

The acquisition unit 210 may acquire vehicle information from the vehicle 30. The vehicle information may be, for example, information indicating various states of the vehicle 30, such as engine speed, temperature of various parts (e.g., an engine) of the vehicle 30, and a malfunction code. The acquisition unit 210 may transfer the acquired vehicle information to the communicator 220 or the information controller 230.

The communicator 220 may communicate with the information processing apparatus 10 via the network 15. For example, the communicator 220 may transmit, to the information processing apparatus 10 via the network 15, the vehicle information acquired by the acquisition unit 210 or the inspection information of the vehicle 30 inputted to the first communication terminal 20 by the user of the first communication terminal 20.

The communicator 220 may also receive the Web screen data generated by the information processing apparatus 10 from the information processing apparatus 10. The communicator 220 may transfer the Web screen data to the display 260 via the information controller 230.

The information controller 230 may transfer information that the first communication terminal 20 has to relevant parts included in the first communication terminal 20. For example, the information controller 230 may transfer the Web screen data received by the communicator 220 to the display 260. Thus, the display 260 may display a Web screen based on the Web screen data.

The storage 240 may store information. For example, the storage 240 may store information such as the vehicle information acquired from the vehicle 30 by the acquisition unit 210 or information inputted to the input unit 250. The information stored in the storage 240 may be transferred to the communicator 220 via the information controller 230, and transmitted to the information processing apparatus 10 by the communicator 220, for example.

The input unit 250 may input information to the information controller 230. The input unit 250 may be, for example, a known input unit such as a keyboard, a mouse, or a touch panel. By operating the input unit, the first user may input, to the information controller 230, inspection information indicating, for example, a progress status of inspection or inspection results. The inputted information may be transmitted to the information processing apparatus 10 via the communicator 220.

The display 260 may be any of various known monitors that display images. For example, the display 260 may display a Web screen based on first Web screen data. The first Web screen data may be received from the information processing apparatus 10 by the communicator 220. By viewing the first Web screen, the first user is able to check the inspection procedure of the vehicle 30.

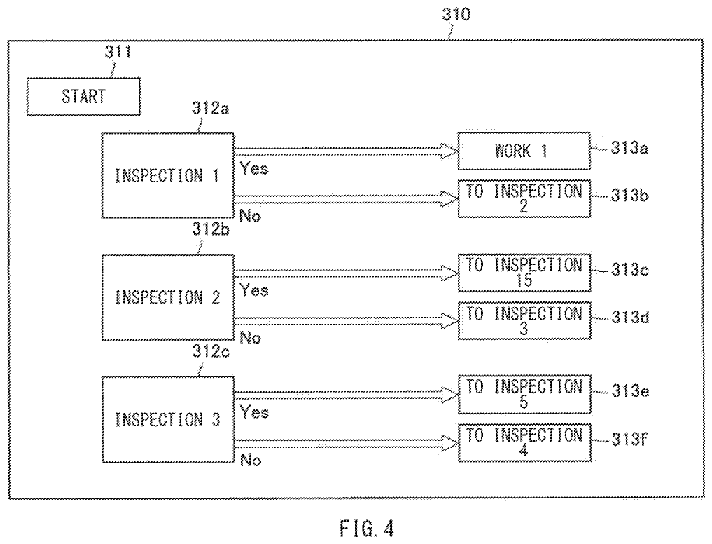

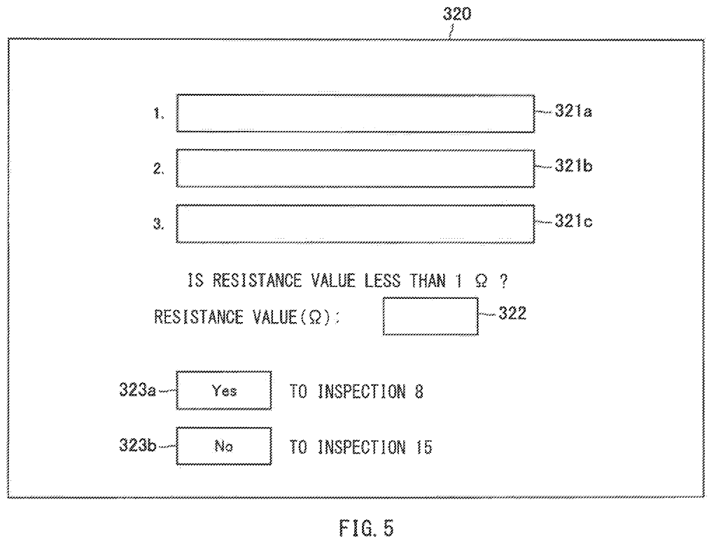

Here, the first Web screen displayed on the display 260 will be described with reference to FIGS. 4 and 5. FIG. 4 illustrates an example of the first Web screen that presents a flow of inspection work.

First, a first Web screen 310 illustrated in FIG. 4 will be described. For example, the first Web screen may be a Web screen presenting a start screen of inspection of the vehicle 30. The first Web screen 310 may display a start button 311, images 312 indicating inspection contents, and images 313 indicating next inspection contents. Note that the first Web screen 310 may display a vehicle identification number of the vehicle 30 to be inspected.

By the first user inputting the inspection information to the information controller 230 by using the input unit 250, the information controller 230 may perform various kinds of control, the first user viewing the first Web screen 310. For example, when the first user operates the start button 311 by using the input unit 250, the information controller 230 may acquire the vehicle information, such as the vehicle identification number, from the vehicle 30 via the acquisition unit 210. The vehicle information may be transmitted from the first communication terminal 20 to the information processing apparatus 10. Thus, in the information processing apparatus 10, the vehicle 30 to be inspected may be associated with the vehicle identification number of the vehicle 30.

Inspection work of the vehicle 30 may be performed in a predetermined procedure. The images 312 may display numbers corresponding to inspection contents to be performed in the respective steps of the inspection procedure. The images 312 may include images indicating inspection contents, or inspection contents may be presented in the inspection procedure, for example, separately from the images 312. The inspector may inspect the vehicle 30 while checking the inspection procedure. Furthermore, of images 312a, 312b, and 312c, images 312 that correspond to steps other than the step in which the inspector is performing inspection may be grayed out. Furthermore, when inspection is started, images 312 other than the image 312a of inspection 1 on the first Web screen 310 may be grayed out.

For example, the inspector may determine Yes or No by comparing a result of inspection corresponding to the image 312a with a predetermined criterion, and perform next inspection depending on a result of the determination. The images 313 may be images indicating next inspection contents that correspond to inspection contents corresponding to the images 312. For example, in a case where the inspector performs inspection indicated by an image 313a after completing inspection in the image 312a, it is possible for the inspector to understand that inspection corresponding to work 1 is to be performed. In a case of performing inspection in an image 313b, it is possible for the inspector to understand that inspection of a content corresponding to inspection 2 is to be performed.

FIG. 5 illustrates an example of a first Web screen 320 that presents an example procedure of inspection work. The first Web screen 320 may be a Web screen that presents an inspection content of a predetermined step in the inspection procedure. Images 321a, 321b, and 321c may be images indicating contents of Nos. 1 to 3 of the procedure for performing inspection in the predetermined step. The inspector may inspect the vehicle 30 in accordance with the images 321.

For example, the image 321c may indicate that a resistance value of a predetermined component included in the vehicle 30 is to be measured. The inspector may measure the resistance value of the predetermined component as indicated by the image 321c. As presented below the image 321c, an instruction may be given to the inspector to determine whether the resistance value is, for example, less than 1Ω. The inspector may determine whether the measured resistance value is less than 1Ω, and, depending on a result of the determination, may operate an image 323a indicating Yes or an image 323b indicating No by using the input unit 250. In response to the operation, as an example, the inspector may perform inspection 8 or inspection 15 here.

At this occasion, by the inspector operating the image 323a or 323b indicating Yes or No by using the input unit 250, progress information may be transmitted from the communicator 220 to the information processing apparatus 10 via the information controller 230. In one example, information indicating that inspection presented in the first Web screen 320 has been completed, and information indicating that inspection contents will go to next inspection work corresponding to Yes or No may be transmitted as the progress information to the information processing apparatus 10. Information indicating a state of the vehicle 30 inputted by the inspector may also be transmitted to the information processing apparatus 10. The information processing apparatus 10 may generate new first Web screen data on the basis of the progress information, and transmit the new first Web screen data to the first communication terminal 20. Accordingly, the display 260 may display a new Web screen, making it possible for the inspector to perform next inspection while viewing the new Web screen. Note that the first communication terminal 20 may transmit the progress information and the information indicating a state of the vehicle 30 to the information processing apparatus 10 in a case where the first Web screen is closed by operation by the first user.

Moreover, it is possible for the inspector to input, by using the input unit 250, electrical characteristics (e.g., a resistance value or a voltage value) of a component included in the vehicle 30 to the information controller 230, as the inspection information. In the example illustrated in the first Web screen 320 in FIG. 5, the inspector is able to input the measured resistance value to the information controller 230 to, for example, cause the resistance value to be displayed in an image 322. Note that, in a case where the first user operates an image 323a indicating Yes or an image 323b indicating No by using the input unit 250 in a state in which the resistance value is not displayed in the image 322, an error may be displayed on the first Web screen 320.

By the resistance value being inputted to the information controller 230, the communicator 220 may transmit the resistance value, as the inspection information, to the information processing apparatus 10. The controller 110 may generate second Web screen data that includes information indicating the electrical characteristics, and transmit the second Web screen data to the second communication terminal 40 via the communicator 120. A second Web screen based on the second Web screen data may be displayed on the display unit included in the second communication terminal 40. This enables the adviser, i.e., the user of the second communication terminal 40, to view the second Web screen, and give more appropriate advice to the inspector.

### [Second Communication Terminal]

The second communication terminal 40 may acquire information from the information processing apparatus 10, and display the information on the display unit included in the second communication terminal 40. For example, the second communication terminal 40 may receive the second Web screen data generated by the controller 110 of the information processing apparatus 10, and display a second Web screen on the basis of the second Web screen data. The second Web screen data may indicate the inspection information of the vehicle 30. By viewing the second Web screen, the adviser, i.e., the second user, is able to recognize the inspection information of the vehicle 30 performed by the inspector.

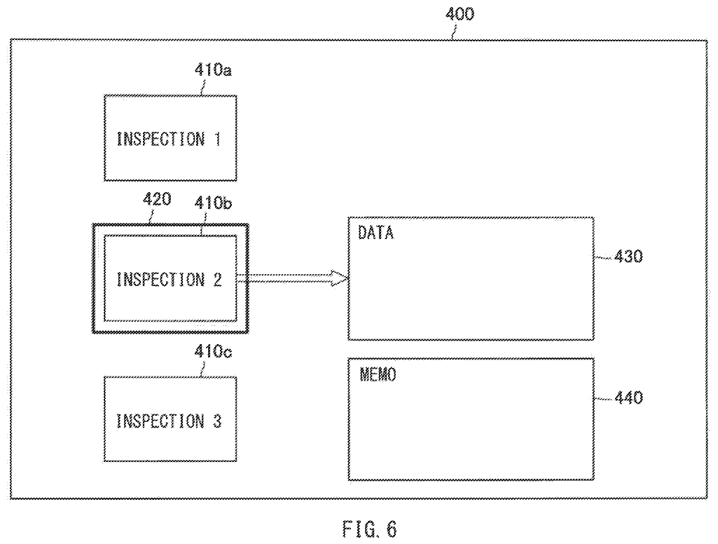

Here, a second Web screen 400 displayed on the display unit included in the second communication terminal 40 will be described. FIG. 6 illustrates an example of the second Web screen 400 according to the example embodiment of the technology. The second Web screen 400 illustrated in FIG. 6 may display images 410a, 410b, and 410c that indicate inspection contents of the respective steps of inspection work. Moreover, the image 410b that indicates a content actually inspected by the inspector may be surrounded by a quadrangular frame 420. The frame 420 may be highlighted in, for example, yellow. By viewing the second Web screen, the second user is able to recognize what kind of inspection the inspector has performed.

On the right side of the image 410b may be displayed a data image 430 indicating a result of inspection in the image 410b. The data image 430 may be data that is inputted to the first communication terminal 20 by the inspector and is transmitted from the first communication terminal 20 to the second communication terminal 40 via the information processing apparatus 10. The data may be information indicating a state of the vehicle that is measured in inspection, such as electrical characteristics of a component included in the inspected vehicle 30. By viewing the data image 430, the second user is able to recognize a state of the inspected vehicle 30 more accurately.

Below the data image 430, a memo image 440 may be displayed. The memo image may display, for example, points that the inspector has noticed in inspecting the vehicle 30. By viewing the memo image 440, the second user is able to recognize a state of the inspected vehicle 30 more accurately.

### 2. Process Example

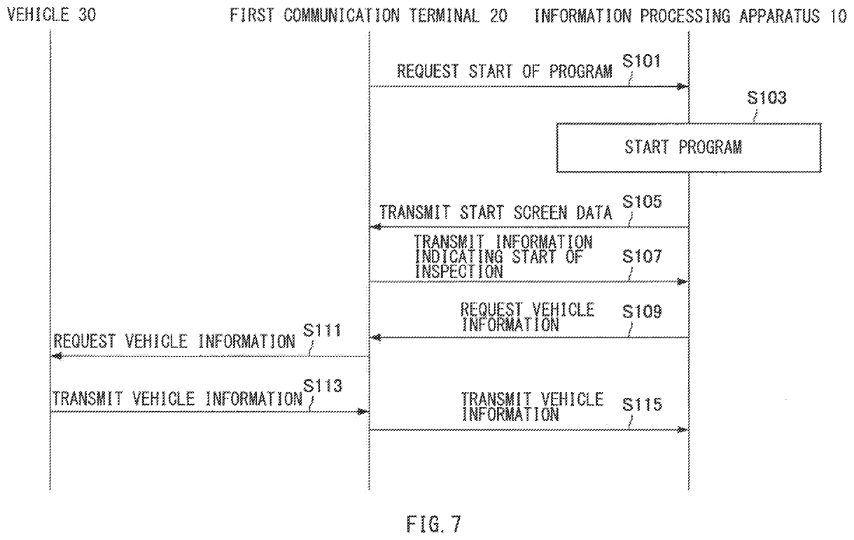

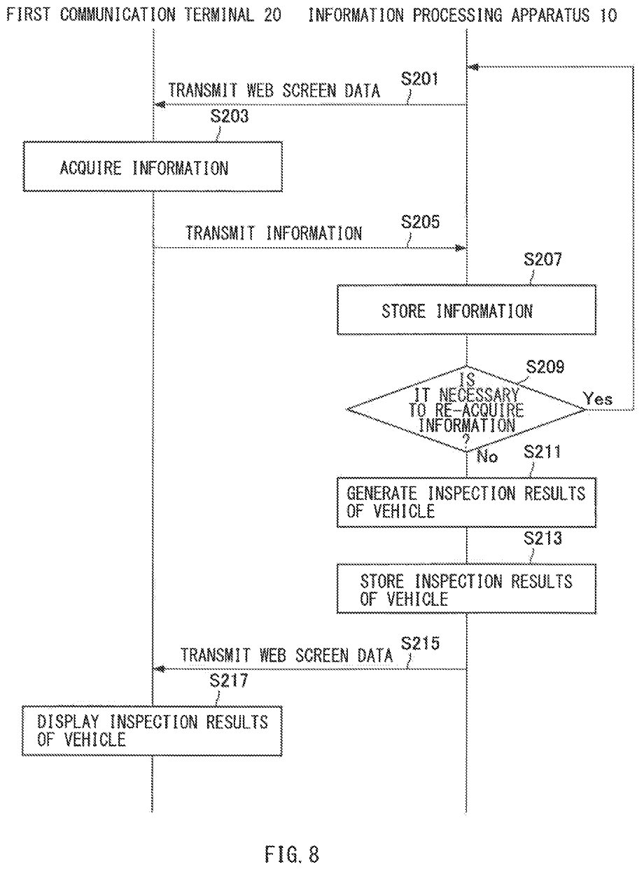

With reference to FIGS. 7 and 8, description will be given on examples of processes that are performed by the information processing apparatus 10 according to the example embodiment of the technology. FIG. 7 is a flowchart illustrating processes performed by the information processing apparatus 10. The processes start with a process in which the information processing apparatus 10 is requested from the first communication terminal 20 to start a program directed to generating Web screen data, and end with a process in which the information processing apparatus 10 receives the vehicle information from the first communication terminal 20. FIG. 8 is a flowchart illustrating processes in which the information processing apparatus 10 transmits the first Web screen data to the first communication terminal 20 in response to data transmitted from the first communication terminal 20. In the example embodiment, the processes illustrated in FIG. 8 may be performed after the processes illustrated in FIG. 7 are performed. First, the processes illustrated in FIG. 7 will be described.

First, the first communication terminal 20 may request, via the network 15, the information processing apparatus 10 to start a program directed to generating the first Web screen data that indicates the inspection procedure of the vehicle 30 (step S101). At this occasion, for example, the first user may operate the input unit 250 to input information requesting start of the program to the information controller 230. The information controller 230 may transmit the information to the information processing apparatus 10 via the communicator 220.

In response to the request from the first communication terminal 20 in step S101, the controller 110 may start a program directed to generating the first Web screen data (step S103). Thereafter, on the basis of source data stored in the screen data storage 132, the controller 110 may generate start screen data indicating an inspection start screen as the first Web screen data, and transmit the start screen data to the first communication terminal 20 via the communicator 120 (step S105). Thus, the display 260 of the first communication terminal 20 may display the start screen as the first Web screen. The start screen may be, for example, the first Web screen 310 illustrated in FIG. 4.

Thereafter, the first communication terminal 20 may transmit, to the information processing apparatus 10, information indicating that the inspector starts inspection of the vehicle 30 (step S107). At this occasion, by operating the input unit 250, for example, the inspector may input the progress information indicating that inspection is started to the information controller 230. The information controller 230 may transmit the progress information to the information processing apparatus 10 via the communicator 220.

Thereafter, the information processing apparatus 10 may request the vehicle information of the first communication terminal 20 (step S109), and the first communication terminal 20 may request the vehicle information of the vehicle 30 (step S111). In response to the request, the vehicle 30 may transmit the vehicle information to the first communication terminal 20 (step S113). Furthermore, the first communication terminal 20 may transmit the vehicle information to the information processing apparatus 10 (step S115). At this occasion, the vehicle information may include various kinds of information related to the vehicle 30, such as the vehicle identification number. The controller 110 may cause the inspection information storage 131 to store the vehicle identification number, which is included in the vehicle information, in association with the vehicle 30 to be inspected.

The processes illustrated in FIG. 7 have been described. Now, processes illustrated in FIG. 8 will be described.

First, the controller 110 may generate the first Web screen data on the basis of progress information, and the communicator 120 may transmit the first Web screen data to the first communication terminal 20 (step S201). The first Web screen based on the first Web screen data may be displayed on the display 260 of the first communication terminal 20 that has received the first Web screen data.

Thereafter, the first communication terminal 20 may newly acquire various kinds of information, such as the vehicle information, the progress information, or the inspection information (step S203), and store the newly acquired information in the storage 240. At this occasion, by communication between the acquisition unit 210 and the vehicle 30, the first communication terminal 20 may acquire the vehicle information, such as the malfunction code, from the vehicle 30. The first communication terminal 20 may also acquire various kinds of information by the first user operating the input unit 250 on the basis of inspection of the vehicle 30.

The first communication terminal 20 may transmit the various kinds of information acquired in step S203 to the information processing apparatus 10 via the communicator 220 (step S205). The information processing apparatus 10 may store the information in the inspection information storage 131 (step S207).

Thereafter, the controller 110 may determine whether it is necessary to re-acquire the information (step S209). In a case where it is determined to be necessary to re-acquire the information (step S209: Yes), the flow may return to step S201, and processes in step S201 to S209 may be performed again. In a case where it is determined to be unnecessary to re-acquire the information (step S209: No), the flow may go to step S211.

When it is determined to be unnecessary to re-acquire the information in step S209, the controller 110 may generate inspection results of the vehicle 30 (step S211). At this occasion, the controller 110 may generate Web screen data directed to displaying a Web screen presenting the inspection results. Thereafter, the inspection information storage 131 may store information indicating the inspection results (step S213).

Thereafter, the communicator 120 may transmit the Web screen data generated in step S211 to the first communication terminal 20 (step S215). The communicator 220 that has received the Web screen data may transfer the Web screen data to the display 260 via the information controller 230.

Thereafter, the display 260 may display a Web screen on the basis of the Web screen data transferred in step S215 (step S217). Thus, by viewing the Web screen, the first user is able to check the inspection results of the vehicle 30.

The processes of the information processing apparatus 10 illustrated in FIG. 8 have been described.

By the processes illustrated in FIG. 7 and FIG. 8, the inspection information storage 131 of the information processing apparatus 10 may store the information related to inspection of the vehicle 30, such as the contents or results of inspection performed by the inspector. The controller 110 is able to generate the second Web screen data that indicates the inspection information. The second communication terminal 40 coupled to the network 15 may receive the second Web screen data from the information processing apparatus 10, and cause the display 260 to display the second Web screen.

### 3. Example Effects

On the basis of the progress information transmitted from the first communication terminal 20, the information processing apparatus 10 according to the example embodiment may generate the first Web screen data that indicates the inspection procedure of the vehicle 30, and transmit the first Web screen data to the first communication terminal 20. The first communication terminal 20 may display the first Web screen on the basis of the first Web screen data. While viewing the first Web screen, the inspector may perform the inspection work. Moreover, the inspector may input the inspection information to the first communication terminal 20 as appropriate, and the inspection information may be transmitted to the information processing apparatus 10 via the network 15.

The information processing apparatus 10 may also generate the second Web screen data on the basis of the inspection information of the vehicle 30, such as the contents or results of inspection performed by the inspector. The second Web screen data may be transmitted to the second communication terminal 40, and the second Web screen based on the second Web screen data may be displayed on the display unit included in the second communication terminal 40. By viewing the second Web screen, the second user is able to recognize the inspection information of the vehicle 30.

Moreover, the second Web screen data may be stored in the screen data storage 132, which enables the second communication terminal 40 to receive the second Web screen data at any time by communicating with the information processing apparatus 10, and display the second Web screen. This enables the second user to, in response to a request from the inspector, view the second Web screen and give advice to the inspector at any time.

In addition, the inspection information of the vehicle 30 may be stored in the information processing apparatus 10, being associated with the vehicle information such as the vehicle identification number of the vehicle 30, a type of the vehicle 30, or the malfunction code. This enables the information processing apparatus 10 to generate the second Web screen data that indicates the inspection information associated with the vehicle information, and transmit the second Web screen data to the second communication terminal 40. The second communication terminal 40 that has received the second Web screen data may display the second Web screen based on the second Web screen data. This enables the second user to, for example, search for the inspection information on the basis of the vehicle information.

### 4. Supplement

The above-described processes, such as the process of generating the Web screen data and the process of transmitting the Web screen data, may be achieved by collaboration between software and hardware that is incorporated in the information processing apparatus 10. Non-limiting examples of the hardware may include a central processing unit (CPU), a read only memory (ROM), and a random access memory (RAM).

Although some embodiments of the technology have been described in the foregoing by way of example with reference to the accompanying drawings, the technology is by no means limited to the embodiments described above. It should be appreciated that modifications and alterations may be made by persons skilled in the art without departing from the scope as defined by the appended claims. The technology is intended to include such modifications and alterations in so far as they fall within the scope of the appended claims or the equivalents thereof.

The steps in a process of the information processing apparatus according to some embodiments need not be performed in a time series in accordance with the order described in the flowcharts. In some embodiments, the steps in the process of the information processing apparatus may be performed in an order different from the order described by the flowcharts or may be performed in parallel.

In the example embodiment, the information processing apparatus 10 may receive, from the first communication terminal 20, the vehicle identification number that the first communication terminal 20 has acquired by communicating with the vehicle 30. Without being limited thereto, the information processing apparatus 10 may receive, from the first communication terminal 20, the vehicle identification number inputted to the first communication terminal 20 by the first user operating the input unit 250. In this case, if the vehicle identification number inputted by the first user is against a predetermined rule, the display 260 may display that the vehicle identification number is against the rule.

It is possible to prepare a computer program that causes hardware incorporated in the information processing apparatus 10 to exert operations equal to those of the respective elements of the above-described information processing apparatus 10. It is also possible to provide a recording medium including the computer program.

The controller 110 and the communicator 120 illustrated in FIG. 2 are each implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the controller 110 and the communicator 120. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and an SRAM, and the nonvolatile memory may include a ROM and an NVRAM. The ASIC is an integrated circuit (IC) customized to perform, and the FPGA is an integrated circuit designed to be configured after manufacturing in order to perform, all or a part of the functions of the controller 110 and the communicator 120 illustrated in FIG. 2.

The example embodiment of the technology makes it possible to present an inspection procedure to an inspector of a vehicle, and easily provide, to a third party, a result of inspection performed on the basis of the inspection procedure.

1. An information processing apparatus comprising:
a controller configured to generate, on a basis of progress information indicating a progress status of inspection of a vehicle, first Web screen data directed to displaying a first Web screen that presents a procedure of inspecting the vehicle;
a screen data transmitter configured to transmit the first Web screen data to a first communication terminal; and
a receiver configured to receive the progress information and inspection information of the vehicle, the progress information and the inspection information being transmitted from the first communication terminal in response to a user operation, the user operation being performed on the first communication terminal that has received the first Web screen data and displayed the first Web screen,
the controller being configured to generate second Web screen data directed to displaying a second Web screen that presents the inspection information,
the screen data transmitter being configured to transmit the second Web screen data to a second communication terminal.

2. The information processing apparatus according to claim 1, further comprising a storage configured to store the second Web screen data.

3. The information processing apparatus according to claim 1, wherein the controller is configured to associate the vehicle to be inspected with a vehicle identification number of the vehicle.

4. The information processing apparatus according to claim 2, wherein the controller is configured to associate the vehicle to be inspected with a vehicle identification number of the vehicle.

5. The information processing apparatus according to claim 3, wherein the controller is configured to generate the second Web screen data that indicates the vehicle identification number and the inspection information of the vehicle corresponding to the vehicle identification number.

6. The information processing apparatus according to claim 4, wherein the controller is configured to generate the second Web screen data that indicates the vehicle identification number and the inspection information of the vehicle corresponding to the vehicle identification number.

7. The information processing apparatus according to claim 1, wherein
the inspection information includes electrical characteristics of a component included in the vehicle, and
the controller is configured to generate the second Web screen data that includes information indicating the electrical characteristics.

8. The information processing apparatus according to claim 2, wherein
the inspection information includes electrical characteristics of a component included in the vehicle, and
the controller is configured to generate the second Web screen data that includes information indicating the electrical characteristics.

9. The information processing apparatus according to claim 3, wherein
the inspection information includes electrical characteristics of a component included in the vehicle, and
the controller is configured to generate the second Web screen data that includes information indicating the electrical characteristics.

10. The information processing apparatus according to claim 4, wherein
the inspection information includes electrical characteristics of a component included in the vehicle, and
the controller is configured to generate the second Web screen data that includes information indicating the electrical characteristics.

11. The information processing apparatus according to claim 5, wherein
the inspection information includes electrical characteristics of a component included in the vehicle, and
the controller is configured to generate the second Web screen data that includes information indicating the electrical characteristics.

12. The information processing apparatus according to claim 6, wherein
the inspection information includes electrical characteristics of a component included in the vehicle, and
the controller is configured to generate the second Web screen data that includes information indicating the electrical characteristics.

13. A non-transitory computer-readable recording medium that includes a program embodied therein, the program causing, when executed by a computer, the computer to implement a method, the method comprising:
generating, on a basis of progress information indicating a progress status of inspection of a vehicle, first Web screen data directed to displaying a first Web screen that presents a procedure of inspecting the vehicle;
transmitting the first Web screen data to a first communication terminal;
receiving the progress information and inspection information of the vehicle, the progress information and the inspection information being transmitted from the first communication terminal in response to an input operation, the input operation being performed on the first communication terminal that has received the first Web screen data and displayed the first Web screen;
generating second Web screen data directed to displaying a second Web screen that presents the inspection information; and
transmitting the second Web screen data to a second communication terminal.

14. A vehicle control apparatus comprising:
a controller configured to generate, on a basis of progress information indicating a progress status of inspection of a vehicle, first Web screen data directed to displaying a first Web screen that presents a procedure of inspecting the vehicle; and
circuitry configured to
transmit the first Web screen data to a first communication terminal, and
receive the progress information and inspection information of the vehicle, the progress information and the inspection information being transmitted from the first communication terminal in response to a user operation, the user operation being performed on the first communication terminal that has received the first Web screen data and displayed the first Web screen,
the controller being configured to generate second Web screen data directed to displaying a second Web screen that presents the inspection information,
the circuitry being configured to transmit the second Web screen data to a second communication terminal.
